(19) United States
(12) Patent Application Publication
(10) Pub. No.: US 2017/0204914 A1
(43) Pub. Date: Jul. 20, 2017

(54) HANDWHEEL CLUTCH FOR USE IN MACHINERY

(71) Applicant: FLAIR INDUSTRY ACCESSORY CO., LTD., TAICHUNG CITY (TW)

(72) Inventor: Sheng-Fu CHANG, TAICHUNG CITY (TW)

(21) Appl. No.: 15/404,478

(22) Filed: Jan. 12, 2017

(30) Foreign Application Priority Data
Jan. 15, 2016 (TW) 105101294

(51) Int. Cl. F16D 11/14; F16D 19/00; F16D 23/14

(52) U.S. Cl. CPC F16D 11/14; F16D 23/14; F16D 19/00; F16D 2011/002

(57) ABSTRACT

A handwheel clutch includes a handwheel mounting unit including an axle sleeve with an external toothed ring portion and a lock nut threaded onto the axle sleeve, and a clutch unit including a clutch member with an internal toothed ring portion sleeved onto the axle sleeve and movable between a first position where the internal toothed ring portion is released from the external toothed ring portion for idle rotation of the clutch member relative to the axle sleeve and a second position where the internal toothed ring portion is meshed with the external toothed ring portion for allowing synchronous rotation of the axle sleeve with the clutch member.

### BACKGROUND OF THE INVENTION

1. Field of the Invention

The present invention relates to machinery technology and more particularly, to a handwheel clutch for use in machinery.

2. Description of the Related Art

When using a machine tool to drive a tool for machining a workpiece, the operator needs to manually drive a handwheel to rotate a handwheel axle, moving the worktable to an appropriate machining position. However, a conventional machine tool does not provide a clutch device between the handwheel and the handwheel axle. Thus, the handwheel can easily be collided by a surrounding staff, resulting in an offset of the worktable and affecting the machining accuracy.

In order to solve the aforesaid problem, Taiwan Patent M492221 discloses a control device for controlling a clutch effect between an operating wheel and an axis tube. When pulls the control device, a plug rod will be moved with the control device axially to shift a plug rod, carrying a movable block toward a positioning block and forcing the movable block into engagement with the positioning block. At this time, the operating wheel can be driven to rotate the axis tube. When releases the control device, the movable block will be forced by a spring member to disengage from the positioning block. At this time, the operating wheel can simply be rotated relative to the axis tube. However, this prior art design has a complicated structure with a large amount of component parts, increasing the machining cost and also complicating the assembly and maintenance works.

### SUMMARY OF THE INVENTION

The present invention has been accomplished under the circumstances in view. It is the main object of the present invention to provide a handwheel clutch, which has the characteristics of simple structure and ease of assembling, and provides a very stable clutch effect.

To achieve this and other objects of the present invention, a handwheel clutch comprises a handwheel mounting unit and a clutch unit. The handwheel mounting unit comprises an axle sleeve and at least one lock nut. The axle sleeve comprises at least one outer thread portion and an external toothed ring portion. The at least one lock nut is respectively threaded onto the at least one outer thread portion. The clutch unit comprises a clutch member and a return spring. The clutch member is adapted for the mounting of a handwheel. Further, the clutch member comprises an axial hole and an internal toothed ring portion. The axial hole is coupled to the axle sleeve. The internal toothed ring portion is extended around an inside wall of the clutch member within the axial hole. The return spring is mounted around the axle sleeve to push the internal toothed ring portion of the clutch member.

Thus, when the clutch member is in a first position, the internal toothed ring portion of the clutch member is released from the external toothed ring portion of the axle sleeve. At this time, the clutch member will run idle relative to the axle sleeve, so that the handwheel cannot drive the handwheel axle to rotate. On the contrary, when the clutch member is in a second position, the internal toothed ring portion of the clutch member is meshed with the external toothed ring portion of the axle sleeve. At this time, the clutch member and the axle sleeve can be synchronously rotated so that the handwheel can drive the handwheel axle to rotate.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a handwheel clutch in accordance with the present invention.

FIG. 2 is an exploded view of the handwheel clutch in accordance with the present invention.

FIG. 3 is sectional view of the present invention, illustrating the clutch member in the first position.

FIG. 4 is sectional view of the present invention, illustrating the clutch member in the second position.

### DETAILED DESCRIPTION OF THE INVENTION

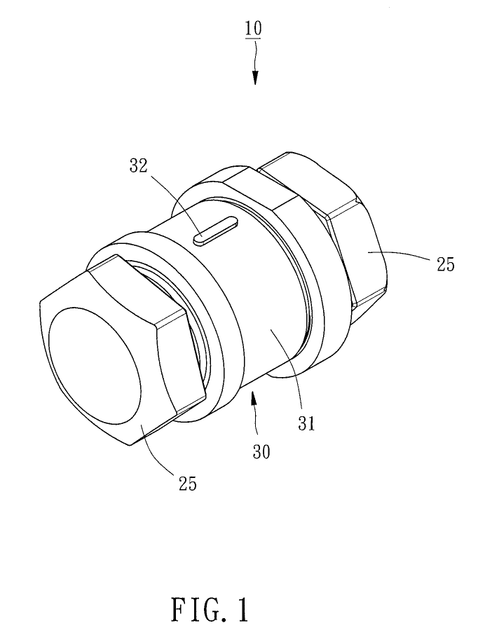

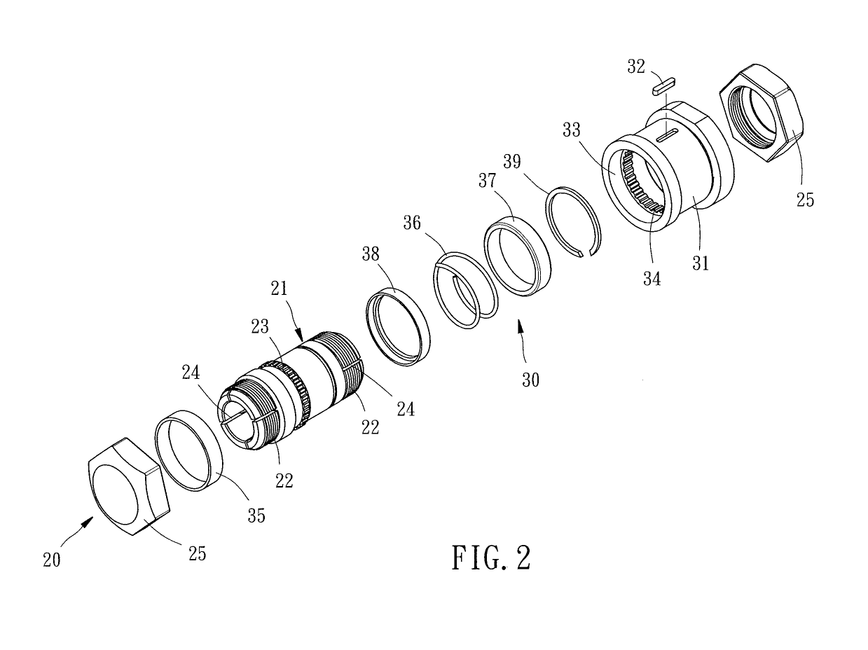

Referring to FIGS. 1 and 2, a handwheel clutch 100 for use in machinery in accordance with the present invention is shown. The handwheel clutch 100 comprises a handwheel mounting unit 20 and a clutch unit 30.

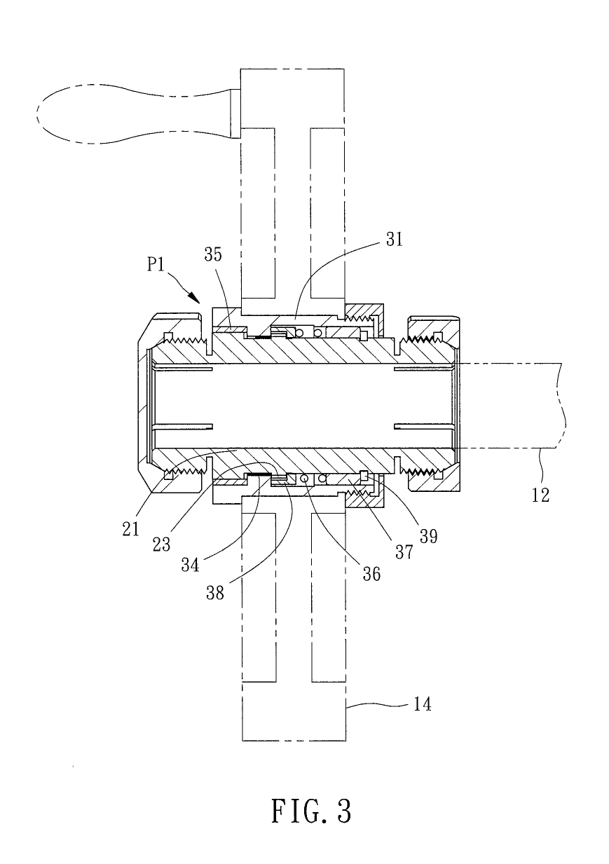

The handwheel mounting unit 20 comprises an axle sleeve 21 and two lock nuts 25. The axle sleeve 21 is adapted for attaching onto a handwheel axle 12 (see FIG. 3), comprising two outer thread portions 22 symmetrically located on two opposite ends thereof and an external toothed ring portion 23 extended around the periphery thereof and spaced between the two outer thread portions 22. The two lock nuts 25 are respectively threaded onto the two outer thread portions 22 of the axle sleeve 21. Thus, when fastening up the lock nuts 25 after sleeved the axle sleeve 21 onto the handwheel axle 12, the axle sleeve 21 and the handwheel axle 12 are locked together. Further, each outer thread portion 22 of the axle sleeve 21 has four longitudinal splits 24 (actually at least one is enough). Subject to the arrangement of the longitudinal splits 24, the outer thread portion 22 of the axle sleeve 21 will be radially deformed after fastened tight the respective lock nut 25, enhancing the connection tightness between the axle sleeve 21 and the handwheel axle 12.

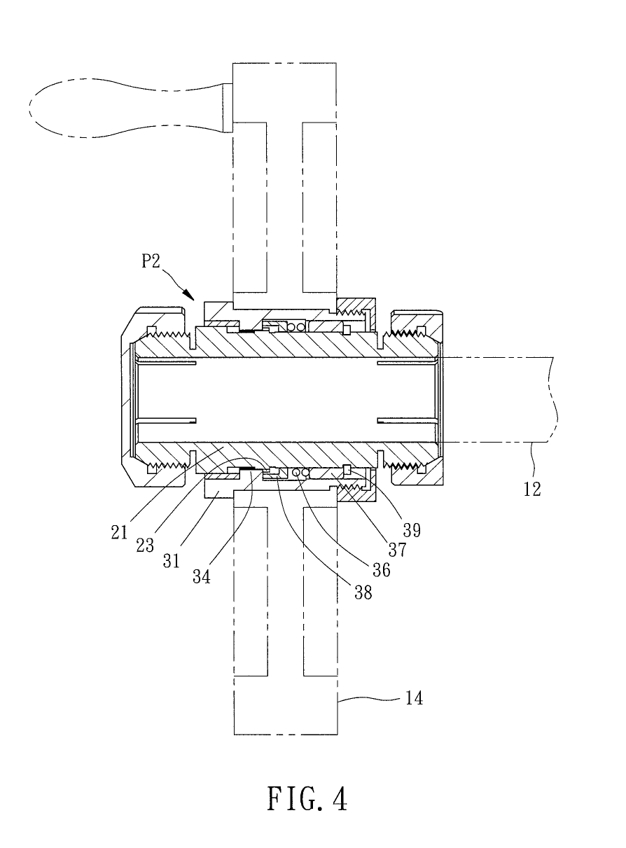

The clutch unit 30 comprises a clutch member 31. The clutch member 31 is adapted for the mounting of a handwheel 14 (see FIG. 3). Further, a flat key 32 is mounted in the clutch member 31 to secure the clutch member 31 and the handwheel 14 together. Further, the clutch member 31 comprises an axial hole 33. By means of the axial hole 33, the clutch member 31 can be attached onto the axle sleeve 21, and moved axially along the axle sleeve 21 between a first position P1 (see FIG. 3) and a second position P2 (see FIG. 4). The clutch member 31 further comprises an internal toothed ring portion 34 extended around an inside wall thereof within the axial hole 33.

When the clutch member 31 is in the first position P1 as shown in FIG. 3, the internal toothed ring portion 34 of the clutch member 31 is released from the external toothed ring portion 23 of the axle sleeve 21. On the contrary, when the clutch member 31 is in the second position P2 as shown in FIG. 4, the internal toothed ring portion 34 of the clutch member 31 is meshed with the external toothed ring portion 23 of the axle sleeve 21. Further, as shown in FIG. 3, an axle bearing 35 is set between the clutch member 31 and the axle sleeve 21. When the clutch member 31 is in the first position P1, the clutch member 31 can be rotated relative to the axle sleeve 21 by means of the axle bearing 35. The clutch unit 30 further comprises a return spring 36, a locating ring 37, and a movable ring 38. The return spring 36 is mounted around the axle sleeve 21 and disposed in the axle hole 33 of the clutch member 31. The locating ring 37 is attached onto the axle sleeve 21 and stopped at one end of the return spring 36, and thus, the locating ring 37 is forced by the return spring 36 to abut against a C-shaped retainer 39 at the axle sleeve 21. The movable ring 38 is attached onto the axle sleeve 21 and stopped at an opposite end of the return spring 36, and thus, the movable ring 38 is forced by the return spring 36 to abut against the internal toothed ring portion 34 of the clutch member 31.

Thus, when enabling the handwheel 14 to drive the handwheel axle 12, move the clutch member 31 from the first position P1 shown in FIG. 3 to the second position P2 shown in FIG. 4. After the clutch member 31 reached the second position P2, the internal toothed ring portion 34 of the clutch member 31 is meshed with the external toothed ring portion 23 of the axle sleeve 21. At this time, subject to the meshed relationship between the clutch member 31 and the axle sleeve 21, the handwheel 14 can be driven to rotate the handwheel axle 12. Further, when moving clutch member 31 toward the second position P2, the internal toothed ring portion 34 of the clutch member 31 is forced to push the movable ring 38 against the return spring 36, thereby compressing the return spring 36 to store elastic restoring energy.

When going to release the transmission relationship between the handwheel 14 and the handwheel axle 12, release the pull force from the clutch member 31. At this time, the clutch member 31 will be forced by the elastic restoring energy of the return spring 36 to return to the first position P1 shown in FIG. 3 and to disengage the internal toothed ring portion 34 thereof from the external toothed ring portion 23 of the axle sleeve 21. Thus, when the handwheel 14 is rotated, the clutch member 31 will run idle relative to the axle sleeve 21, avoiding rotation of the handwheel axle 12 with the handwheel 14.

In conclusion, the handwheel clutch 10 of the invention uses the meshing relationship between the internal toothed ring portion 34 of the clutch member 31 and the external toothed ring portion 23 of the axle sleeve 21 to achieve the clutch effect between the handwheel 14 and the handwheel axle 12. When compared to the prior art techniques, the invention on the one hand simplifies the structure to reduce the processing cost and to facilitate the subsequent assembly process, and, on the other hand, provides a very stable clutch effect in operation to achieve the expected objectives.

What is claimed is:

1. A handwheel clutch for use in machinery, comprising:
a handwheel mounting unit comprising an axle sleeve and at least one lock nut, said axle sleeve comprising at least one outer thread portion and an external toothed ring portion, said at least one lock nut being respectively threaded onto said at least one outer thread portion; and
a clutch unit comprising a clutch member and a return spring, said clutch member comprising an axle hole coupled to said axle sleeve for enabling said clutch member to be rotated relative to said axle sleeve and moved along said axle sleeve between a first position and a second position, said clutch member comprising an internal toothed ring portion extended around an inside wall thereof within said axle hole, said internal toothed ring portion of said clutch member being released from said external toothed ring portion of said axle sleeve for allowing said clutch member to be rotated relative to said axle sleeve when said clutch member is in said first position, said internal toothed ring portion of said clutch member being meshed with said external toothed ring portion of said axle sleeve for allowing said clutch member to rotate said axle sleeve when said clutch member is in said second position, said return spring being mounted around said axle sleeve and stopped against said internal toothed ring portion of said clutch member to impart an elastic restoring force to said clutch member and to hold said clutch member in said first position.

2. The handwheel clutch for use in machinery as claimed in claim 1, wherein said axle sleeve comprises two said outer thread portions respectively located at two opposite ends thereof; said external toothed ring portion is spaced between the said two outer thread portions; the number of said at least one lock nut is 2, and these two said lock nuts are respectively threaded onto the said two outer thread portions of said axle sleeve.

3. The handwheel clutch for use in machinery as claimed in claim 1, wherein each said outer thread portion of said axle sleeve comprises at least one longitudinal split so that each said outer thread portion of said axle sleeve is radially deformable.

4. The handwheel clutch for use in machinery as claimed in claim 1, wherein said clutch unit further comprises a locating ring and a movable ring, said locating ring being attached onto said axle sleeve and stopped at one end of said return spring, said movable ring being axially slidably mounted around said axle sleeve and stopped between an opposite end of said return spring and said internal toothed ring portion of said clutch member.
